(19) United States
(12) Patent Application Publication
(10) Pub. No.: US 2023/0208663 A1
(43) Pub. Date: Jun. 29, 2023

(54) VOCAL ACTION AUTOMATION FOR CONTROLLING CONFIDENTIAL CONTENT

(71) Applicant: MICROSOFT TECHNOLOGY LICENSING, LLC, Redmond, WA (US)

(72) Inventors: Milica JOVANOVIC, Prague (CZ); Tanner MOEHLE, Prague (CZ); Ondrej ZACEK, Prague (CZ)

(21) Appl. No.: 17/565,355

(22) Filed: Dec. 29, 2021

(51) Int. Cl. H04L 12/18; H04L 9/40; H04L 65/403; G06F 21/84; H04L 51/00

(52) U.S. Cl. CPC H04L 12/1822; H04L 12/1831; H04L 63/101; H04L 65/403; G06F 21/84; H04L 51/12

(57) ABSTRACT

The techniques disclosed herein provide vocal action automation for controlling confidential content within a communication session. A system can monitor the voice of a presenter of a communication session. When the presenter indicates that confidential content is being shared, the system modifies the permissions to restrict audience members from performing actions that capture aspects of the shared content. For example, when the presenter provides an input that indicates they are going to share a confidential slide deck, the system changes the permissions of the audience members by entering a confidentiality mode. While operating in confidentiality mode, the system can restrict functionality for recording the communication session, taking screen shots, coping content, and saving content. The system can also automatically generate a watermark on the content to indicate that the shared content is confidential. The system can also restrict users from adding others to a meeting when the content is displayed.

### BACKGROUND

There are a number of different types of collaborative systems that allow computer users to communicate. For example, some systems allow users to collaborate by sharing content using video streams, shared files, chat messages, emails, etc. Some systems provide user interface formats that allow users to share content with an audience. Such systems can provide specific sets of permissions that allow users to take specific roles, such as a presenter, audience member, etc. When a presenter shares content, such as a spreadsheet, word processing document, or a slide deck, audience members can view the shared content on their respective devices.

Although some existing systems can provide users with the ability to share content, such systems can present a number of drawbacks. For instance, some systems may not provide presenters a granular level of control over permissions for shared content. In some cases, when a presenter shares a document, audience members can download the document or capture screenshots of the presentation. This may not be desirable in situations where the presenter is sharing confidential information.

Some communication systems may also allow audience members to record presentations. Such features may also not be desirable in a situation where a presenter is sharing confidential information. Although some communication programs allow presenters to disable recording capabilities, such program features only provide such functionalities when a user such as a presenter manually stops a recording operation. This result may not be optimal as such manual controls can distract the presenter from the meeting or the shared content.

In addition, when users are required to enable and disable a recording feature, that type of activity may cause distractions to the audience members and also distract presenters who may be required to provide a manual input each time a recording feature is enabled and disabled. Further, existing systems that require a manual input to enable and disable recording features can also present a number of security issues given that a presenter may forget to pause a recording. This can lead to an undesirable scenario where audience members could obtain a recording of confidential information.

### SUMMARY

The techniques disclosed herein provide vocal action automation for controlling confidential content within a communication session. In some configurations, a system can monitor the voice of a presenter of a communication session. When the presenter indicates that confidential content is to be shared, the system modifies the permissions to restrict audience members from performing actions that capture aspects of the shared content. For example, when the presenter provides an input that indicates they are going to share a confidential slide deck, the system changes the permissions of the audience members by entering a confidentiality mode. While operating in confidentiality mode, the system can restrict any recording functionality. Recording functionality can include audio and video recordings of a meeting, e.g., a communication session, screen shots of shared content, any copy or file save functions for content, etc. While operating in confidentiality mode, the system may also restrict one or more participants of a communication session from inviting new participants. The system can also generate a watermark on the content to indicate that the shared content is confidential. The system can also restrict users from adding other people to the communication session.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system and an example of a user interface for a multi-user communication session.

FIG. 2 is a block diagram illustrating examples of permission data in a first state and a second state.

FIG. 3 shows a user interface comprising a notification indicating that a system is operating in a confidentiality mode.

FIG. 4 shows a user interface generated by a system operating in confidentiality mode when additional content is displayed.

FIG. 5 shows a user interface displayed on the computing device operated by a participant having an audience role of a communication session.

FIG. 6 shows a user interface displaying a notification to a user in response to an input for taking a screenshot.

FIG. 7 shows a user interface generated by a computing device operated by a presenter, where the user interface provides a notification that an audience member is attempting to take a screenshot.

FIG. 8 illustrates an input from a participant where the input includes an invitation to invite another user to a communication session.

FIG. 9 shows a user interface generated by a computing device operated by a presenter, where the user interface provides a notification that an audience member is attempting to invite another user to a communication session.

FIG. 10 is a flow diagram showing aspects of a routine for vocal action automation for controlling confidential content.

FIG. 11 is a computer architecture diagram illustrating an illustrative computer hardware and software architecture for a computing system capable of implementing aspects of the techniques and technologies presented herein.

FIG. 12 is a computer architecture diagram illustrating a computing device architecture for a computing device capable of implementing aspects of the techniques and technologies presented herein.

### DETAILED DESCRIPTION

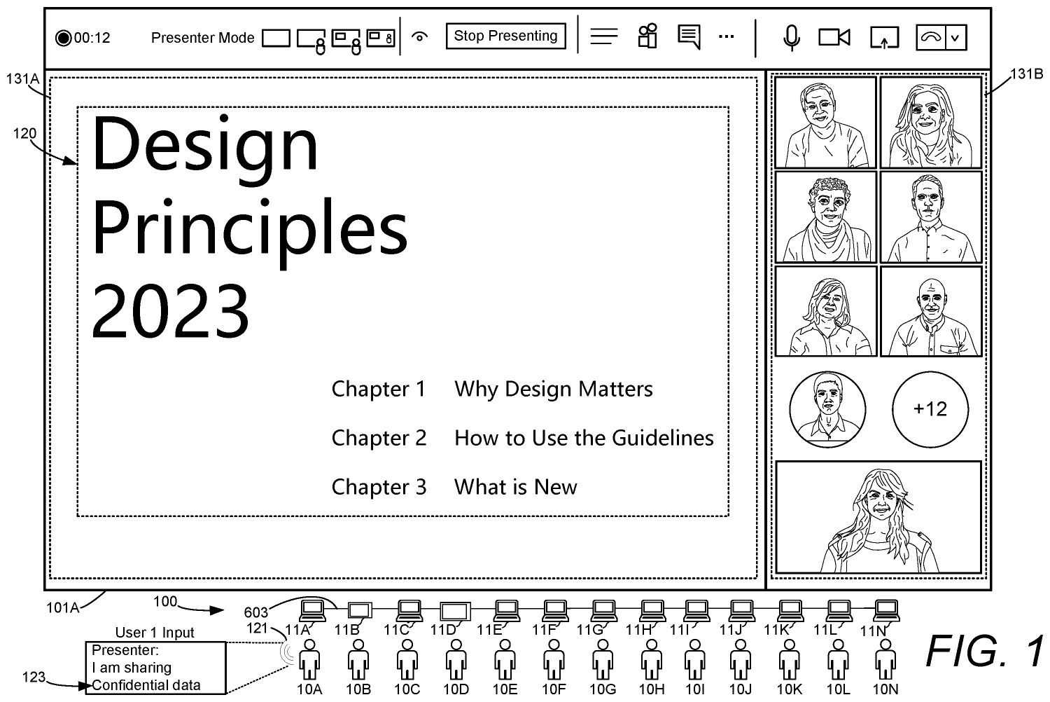

FIG. 1 is a block diagram of a system 100 and an example user interface for providing a communication session 603 for a number of users 10 associated with client computers 11. This example user interface 101A can be displayed to a user having a presenter role within the communication session. In this example, the presenter is the first user 10A operating the first computing device 11A and the user interface 101A is displayed to the first user 10A via the first computing device 11A. The user interface 101A can include a primary presentation area 131A and an attendee image region 131B. The primary presentation region 131A can include a display of content 120 that is controlled by a particular user, such as the first user 10A, having permissions associated with a presenter role. The first user can control the display of the content 120 such that the content 120 can be displayed on the respective computers of other users 10B-10N operating other computing devices 11B-11N.

FIG. 1 through FIG. 3 illustrates an example of a system configured to modify security permissions that allow or restrict functionality that controls shared content 120 using vocal activity of a communication session 603. When a particular user, such as a presenter, provides a vocal input indicating that confidential content is about to be, or is being, shared, the system can enter a confidentiality mode and restrict operations that record or capture the content.

For instance, as shown in FIG. 1, the system can monitor input data 715 defining vocal activity 121 of a user 10A participating in the communication session 603 to identify keywords 123 identifying the confidential content 120 that is shared in the communication session 603. For instance, the presenter can say that “I am sharing confidential data.” The system can analyze such an input and identify predetermined keywords by analyzing audio data. Any combination of keywords can be utilized to determine the presence of confidential information.

Keywords such as confidential, confidentiality, private, privacy, or any other keyword that may indicate that confidential information is to be shared. Any suitable technology can be utilized to determine keywords that are included in audio data produced by the presenter.

The system can analyze keywords to determine a level of confidence respect to the analysis of the keywords. The confidence level can be based on a number of factors including a number of predetermined keywords, frequency of the predetermined keywords, or the presence of one or more predetermined keywords. Other factors can influence the level of confidence, such as a tone of the presenter's voice, inflections in the presenter's voice or emphasis on keywords. If the level of confidence exceeds a threshold, the system may determine the presence of confidential information within a communication session.

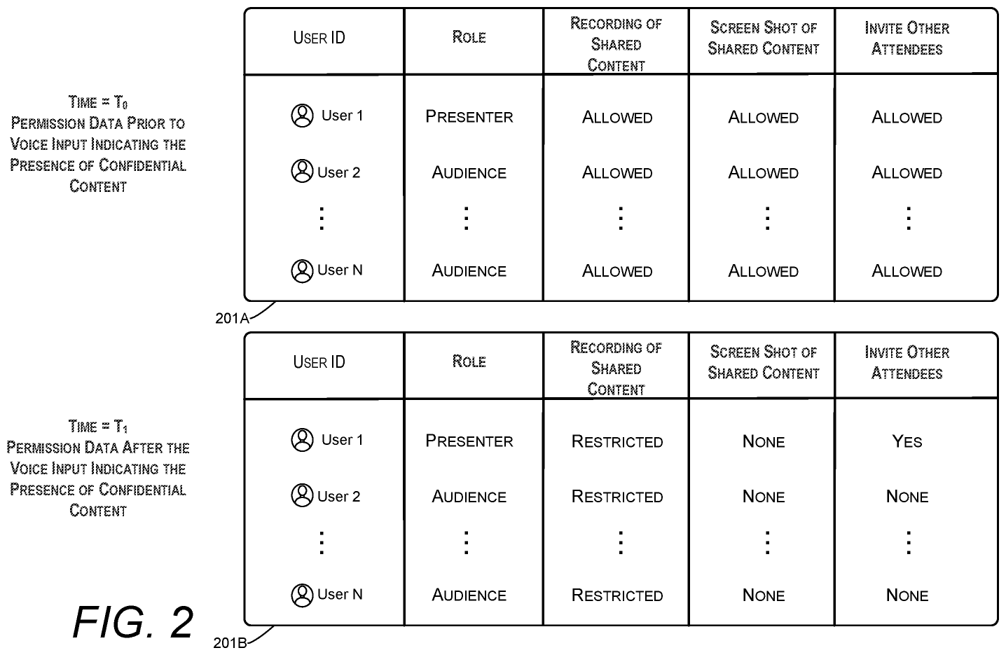

As shown in FIG. 2, in response to determining that the keywords 123 of the input data 715 from the vocal activity 121 meet a threshold requirement for indicating that the confidential content 120 is to be shared, the system can execute a set of batched operations causing the computing system 100 to activate a confidentiality mode. A threshold requirement may include a level of confidence score that exceeds a threshold level or any other condition regarding the predetermined keywords described herein. For example, a threshold requirement may be met when a voice input includes at least one predetermined keyword or at least one predetermined keyword that refers to a name of a file, or a file identifier, or any keyword included in the content. As described below, the batch functions for operating in confidentiality mode can include a number of features including modifications of confidential data, the display of notifications, and restriction of their functions or capturing screenshots or inviting other users to a particular communication session.

As shown in FIG. 2, the batch functions for operating in confidentiality mode can include modifying security permissions 201 for one or more users of the communication session 603. The modification can include transitioning a first state of the security permissions 201A to a second state of the security permissions 201B. The first state of the security permissions 201A can allow specific types of recordings of the confidential content 120 shared in the communication session 603. This can include an audio and video recording functions of the communication session and screenshots of the shared content. As shown in this example, at a first time T₀, each user is allowed to make a recording or start a recording of the communication session. This can include the capturing of video data shared between users as well as share of the shared content. In this first date of the security permissions the system can also allow users to take screenshots and to invite other users to communication session, e.g., a meeting.

After the system transitions the security permissions to a second state the system to restrict various functionality regarding the shared content. For instance, at a second time T₁, after the user provides a voice input that meets the threshold requirement, a second state of the security permissions 201B can include attributes that restrict recordings of the confidential content 120 shared in the communication session 603. In this example, users are restricted from generating a recording of the communication session, restricted from taking screenshots, and restricted from inviting other attendees to the meeting. The restrictions can be on a per user basis and only apply to certain users having certain roles. For instance, in the second state of the security permissions the presenter may maintain control over certain operations such as invitations for other users, or even allowing a recording of the meeting.

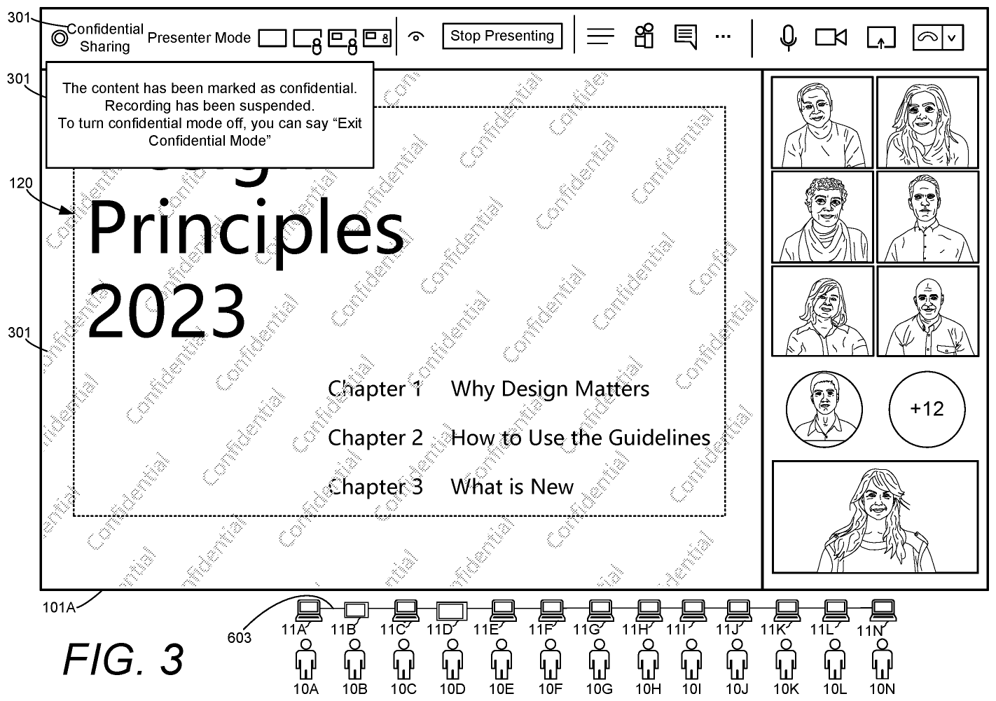

As shown in FIG. 3, in response to the input meeting one or more threshold requirements, the system can modify the display of the user interface to provide notice 301 of the confidentiality mode. The notice can include a text message indicating that recording functionality has been suspended and that confidential information is being displayed. The notice 301 can also include other graphical features such as a watermark within the content or displayed as an overlay over the content. Other types of notifications can be displayed such as a status of the meeting such as the indicator at the top left corner stating “Confidential Sharing.” The display of the notice can be in response to the transition of the security permissions 201 from the first state of the security permissions 201A allowing recordings of the confidential content 120 to the second state of the security permissions 201B.

The notice can also provide instructions for allowing the system to exit the confidentiality mode. In one example, the system can exit the confidentiality mode by detecting an input from the first user, e.g., the presenter, with specific instructions to exit the confidentiality mode. In one illustrative example, the voice instruction can include statements such as, “exit confidentiality mode” or “exit confidential mode.”

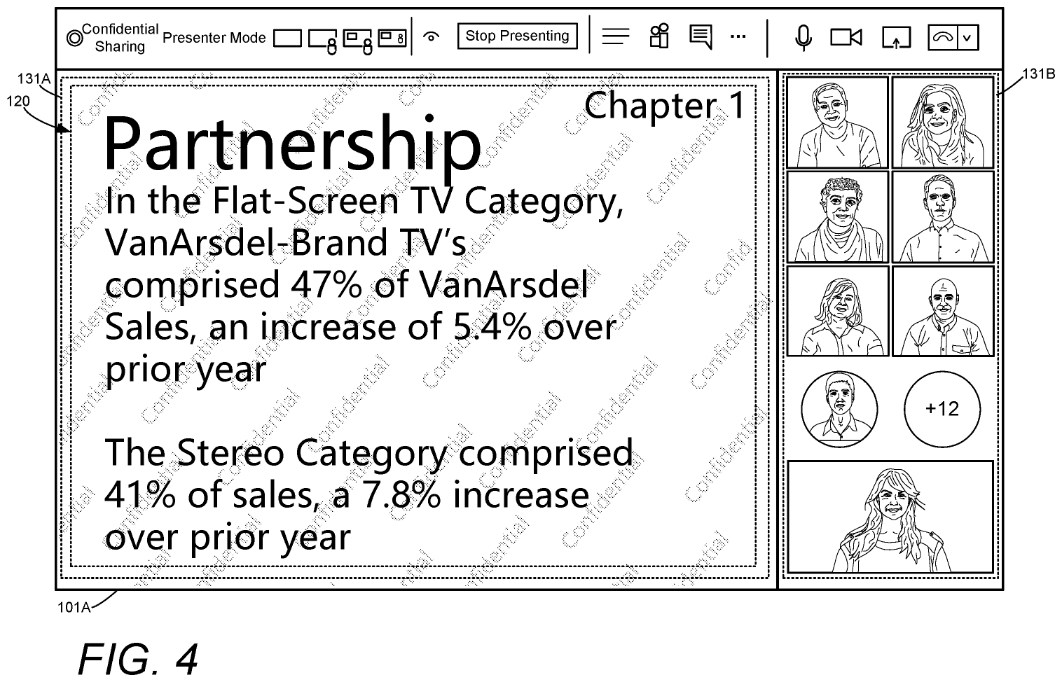

FIG. 4 illustrates an example of additional content that is shared in the communication session. This example shows that, even as the presenter transitions through different slides and presents new content, the system continues to operate in confidentiality mode and, among other restrictions define herein, continues to restrict users from recording information. In addition, the system continues to display one or more indicators show that the system is still operating in the confidentiality mode.

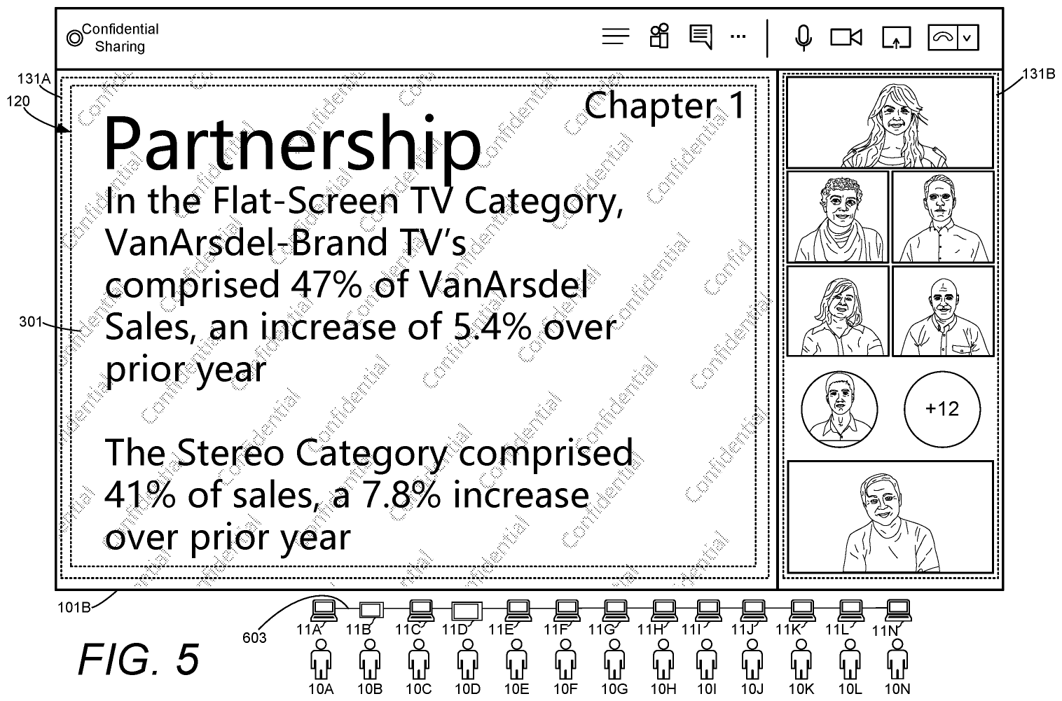

FIG. 5 shows a user interface displayed on the computing device operated by a participant having an audience role of a communication session. As applied to the example above, FIG. 5 illustrates a user interface that is displayed to the second computing device 11B operated by the second user 11B. This user interface includes a primary presentation area 131A and an attendee image region 131B. The primary presentation region 131A can include a display of content 120 that is controlled by a particular user, such as the first user 10A, having permissions associated with a presenter role. Also shown in this example, the user interface can include one or more visual indicators 130 for providing a notification that system is operating in the confidentiality mode.

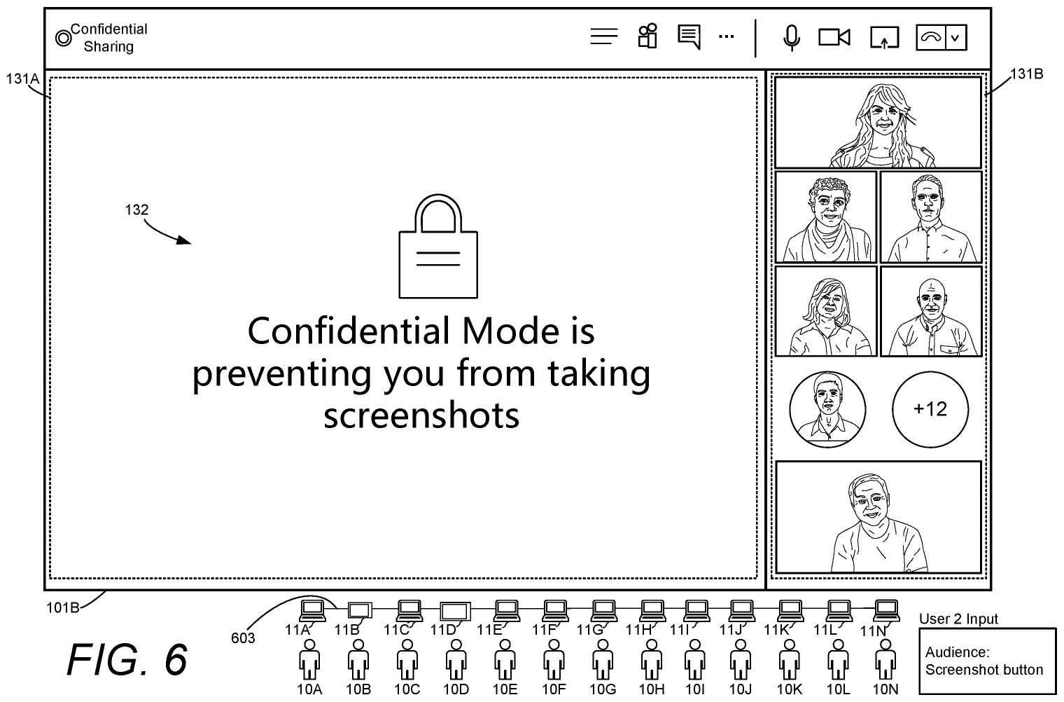

FIG. 6 shows a user interface displaying a notification to a user in response to an input for taking a screenshot. In this example, the second user provides an input causing their corresponding computing device to take a screenshot while the system is operating in confidentiality mode. In response to receiving an input for invoking operations for capturing, e.g., recording, a screenshot while the device is operating in confidentiality mode, the system responds by providing a notification 132 that a screenshot is restricted. The notification can include a graphical icon and/or text to indicate that a screenshot is prohibited. In one illustrative example, when the system receives an input for invoking a screenshot while the system is operating in confidentiality mode, the system may transition from a first user interface arrangement 101B shown in FIG. 5 to a second user interface arrangement 101B shown in FIG. 6.

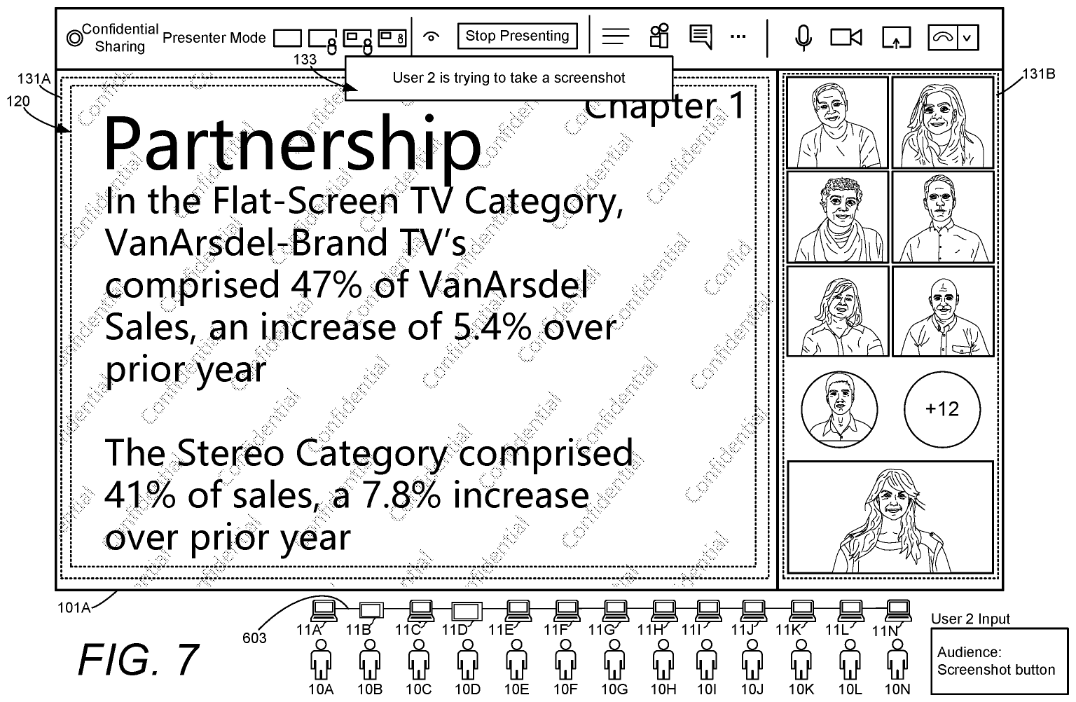

FIG. 7 shows a user interface generated by a computing device operated by a presenter, where the user interface provides a notification that an audience member is attempting to take a screenshot. This user interface can be displayed to the presenter when another user, such as the second user, provides an input for invoking operations for capturing a screenshot while the system is operating in confidentiality mode. This feature can allow the system to provide a notice of user activity to a presenter.

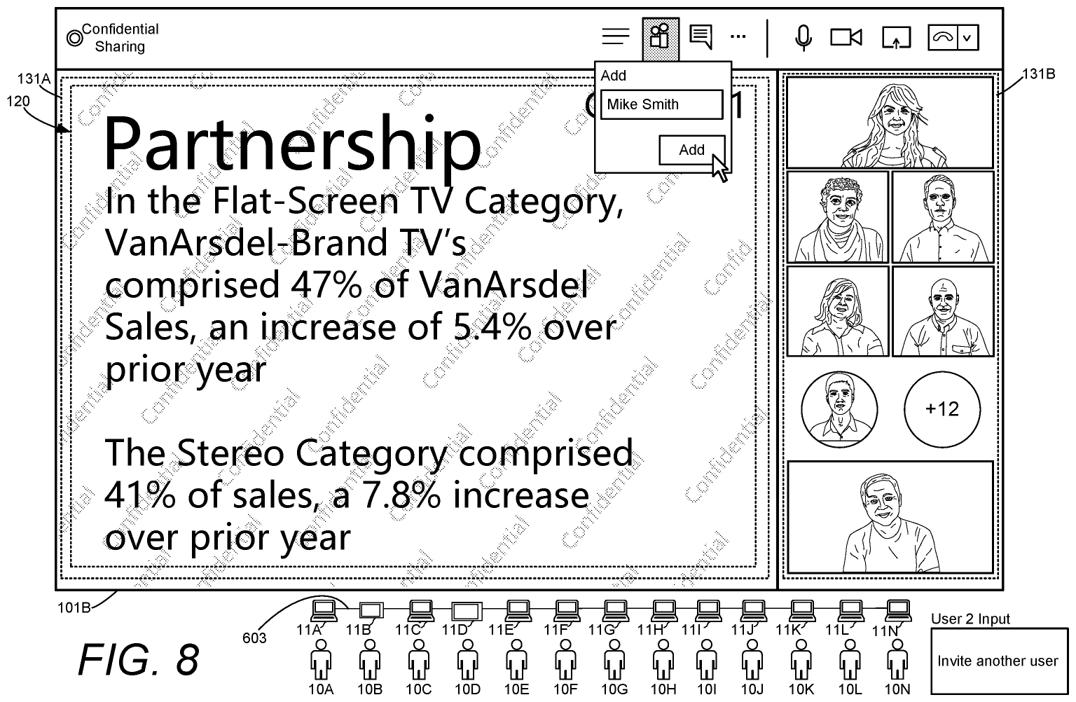

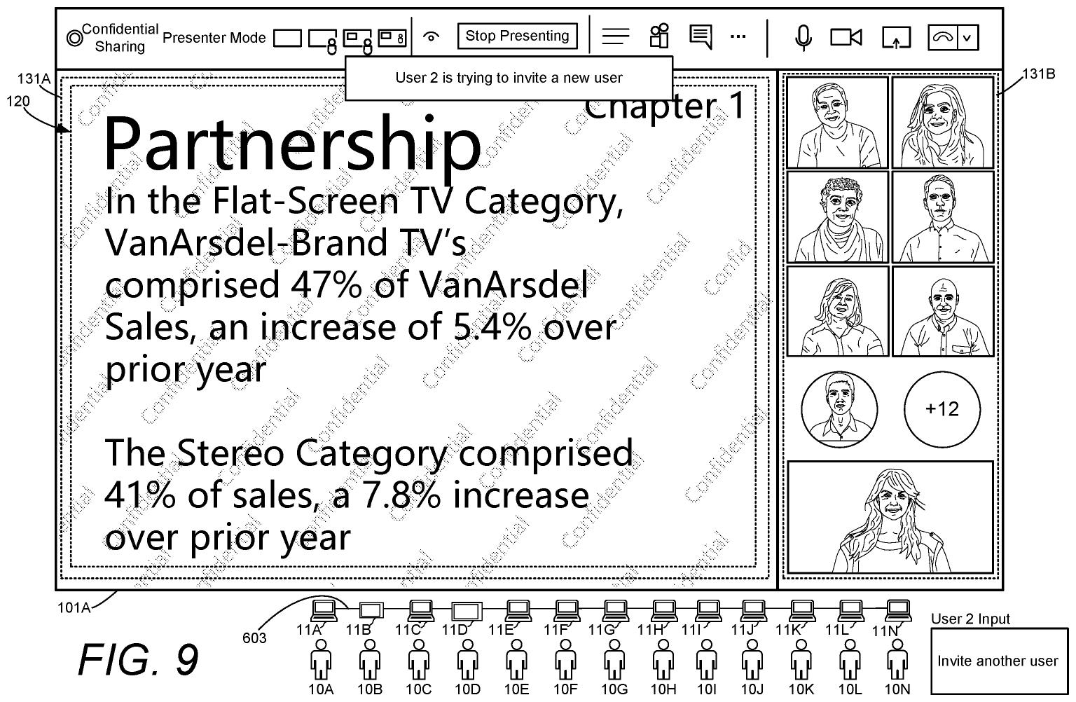

FIG. 8 illustrates an input from a participant, such as the second user, where the input includes an invitation to invite another user to a communication session. FIG. 9 shows a user interface generated by a computing device operated by a presenter, where the user interface provides a notification that an audience member is attempting to invite another user to a communication session while the system is in confidentiality mode.

In some configurations, when a system activates the confidentiality mode, the security permissions 201 can cause the system to restrict one or more computing devices associated with other users, such as User 2 through User N, from inviting additional participants to the communication session. In such an embodiment, the system can receive an input for generating an invitation from an audience member, such as the second user. As shown in FIG. 8, the input can identify another user, such as the third user 10C, to be invited to the communication session 603. The system can then restrict the other user, e.g., the third user, from joining the communication session. This restriction can be caused by the permission data. In particular, this restriction can be caused by the permission data after the system has caused the transition of the security permissions (201) from the first state of the security permissions to the second state of the security permissions, wherein the second state of the security permissions restricts the addition of the third person from joining the communication session and restricts the third person from receiving the confidential content (120).

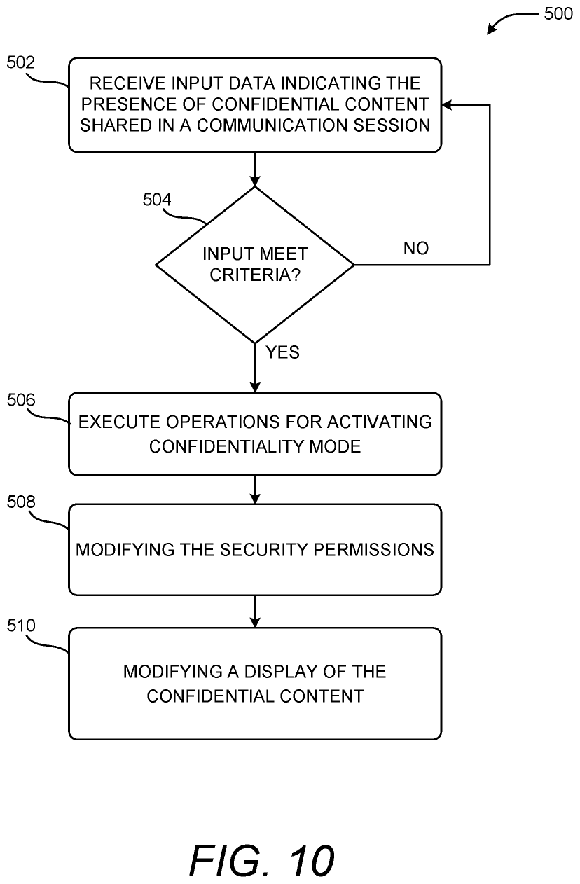

FIG. 10 is a diagram illustrating aspects of a routine 500 for modifying security permissions 201 controlling the communication of confidential content 120 using vocal activity of a communication session 603. It should be understood by those of ordinary skill in the art that the operations of the methods disclosed herein are not necessarily presented in any particular order and that performance of some or all of the operations in an alternative order is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a system, e.g., one or more computing devices, it can be appreciated that this routine can be performed on any computing system which may include any number of computers working in concert to perform the operations disclosed herein.

Thus, it should be appreciated that the logical operations described herein are implemented as a sequence of computer implemented acts or program modules running on a computing system such as those described herein and/or as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Additionally, the operations illustrated in FIG. 10 and the other FIGURES can be implemented in association with the example presentation user interfaces UI described above. For instance, the various devices and/or modules described herein can generate, transmit, receive, and/or display data associated with content of a communication session e.g., live content, broadcasted event, recorded content, etc. and/or a presentation UI that includes renderings of one or more participants of remote computing devices, avatars, channels, chat sessions, video streams, images, virtual objects, and/or applications associated with a communication session.

The routine 500 includes an operation 502 where the system can receive input data 715 indicating the presence of confidential content within a communication session. The input data can include video data, audio data, or any other form of input data that can be for interpreting keywords or one or more predetermined gestures. For example, video data can be utilized by the system to analyze a person's gestures to indicate the presence of confidential content that will be, or is, shared within a communication session. A user can share content by displaying a screen of a program wherein the display includes distributing the rendering to other users of each medication session. In some embodiments, the input data 715 can define vocal activity 121 of a user 10A participating in the communication session 603.

In some configurations, the system may only monitor the voice of a presenter, e.g., analyze the audio channel of users having permissions to share content on the screen of other users. By only analyzing the audio channel of the presenter(s), the system can give more control of a meeting to the presenters and reduce the number of false-positive readings that confidential content is being shared. For example, this embodiment can eliminate the need for a system to monitor vocal activity of the audience, which may inadvertently activate the confidentiality mode when the presenters are not deeming the shared content as confidential.

In operation 504, the system can monitor the input data 715 defining vocal activity 121 of a user 10A participating in the communication session 603 to identify keywords 123 identifying the confidential content 120 shared in the communication session 603. For instance, audio data can be translated to interpret a transcript and the transcript may include keywords such as “confidential content will be shared,” etc. At operation 504, when the system determines that the input data does not meet one or more criteria, the routine returns to 502 where the system can receive additional input data for analysis. However, at operation 504 when the system determines that the input data meets one or more criteria, the routine continues to operation 506.

In some configurations, the system can determine that the input meets one or more criteria when the keywords 123 of the input data 715 caused by the vocal activity 121 meet a threshold requirement for indicating that the confidential content 120 is be shared. As described herein, the threshold requirement can include a number of keywords, a frequency of keywords, etc.

At operation 506 the system can execute operations for activating the confidentiality mode when the system determines that the input data meets the criteria. In some configurations, the system can cause each computing device of a communication session to activate a confidentiality mode. During operation in confidentiality mode, each computing device may be restricted from capturing screenshots, conducting any type of recording of confidential content, and restricted from allowing users to invite individuals to a communication session.

At operation 508, the system may modify the security permissions 201 for one or more users of the communication session 603 wherein the modification causes a transition from a first state of the security permissions 201A allowing recordings of the confidential content 120 shared in the communication session 603 to a second state of the security permissions 201B restricting recordings of the confidential content 120 shared in the communication session 603. The second state of the security permissions can include attributes that restrict users from taking screenshots, storing shared content within a storage medium, or inviting one or more users to a communication session.

At operation 510, the system can modify a display of the confidential content 120 to provide a visual indication 301 of the confidentiality mode in response to the transition of the security permissions 201 from the first state of the security permissions 201A allowing recordings of the confidential content 120 to the second state of the security permissions 201B restricting recordings of the confidential content 120. The modification of the display can include adding a watermark to shared content, displaying text messages within an application user interface to indicate that a computer is operating in confidentiality mode, or causing a change in any other display property, e.g., brightness or color, to indicate that a computer is operating in confidentiality mode and also to highlight confidential content.

In some configurations, the techniques disclosed herein can include a timing features for determining when the confidentiality mode is to be activated and when it is to be terminated. For example, in the detection of the keywords, if the system determines that the user is going to present confidential information in the future, the system may delay the initiation of the confidentiality mode based on the keywords. In one specific example, if user says slide 5 contains confidential information, the system will only invoke the confidentiality mode while slide 5 is displayed in the communication session to other users, and the system may disable the confidentiality mode when slide 5 is no longer displayed to the users.

This example is for illustrative purposes and is not to be construed as limiting. The confidentiality mode can begin and end with any type of delineation within the content. For instance, if user says page 5 of a word document or specific cells within a spreadsheet, the confidentiality mode will only be activated when that confidential content is being displayed. Thus, the system can detect specific segments of the shared content and only activate the confidentiality mode when those specific segments are displayed to users. The detection process can also identify entire files. Thus, if a user says that an entire document or an entire slide deck is confidential, the system can activate and deactivate the confidentiality mode when any section of that document or slide deck is presented. The system can also deactivate the confidentiality mode when those sections are no longer presented in a communication session, e.g., shared on a screen share or in an online meeting.

In another example, when a presenter states that confidential content is being shared, the system may stop a recording process or disable any new recordings from being started. If a recording process is in operation at the time of the input, the system may truncate the recording file to remove any portion of the recording that includes the confidential content. This may be done in a number of ways. For example, the system may analyze the video recording and then determine that content that was shared during the input, e.g., slide 5 of a deck, is present a portion of the recording. The system then removes that identified portion of the recording.

These features automate the process further which enables the presenter to focus on the content. By improving the user interaction between a person and a computer, a number of efficiencies can be provided. For instance, if a presenter can focus on the content instead of activating and deactivating recording features manually, the techniques disclosed herein can improve the security of a system because it can reduce the number of inadvertent inputs. The techniques disclosed herein can improve the security of a system because it may activate a confidentiality mode and prevent users from recording content even if a presenter forgets to manually activate the confidentiality mode or manually disable recording features.

In one example, the system can also identify the shared content within a user interface. Once the shared content is identified, the system can distinguish the shared content from other types of renderings such as the renderings of each participant. In this way, the system can record the activity of the users but block out the shared content from the recording. This enables recording functionality to be performed during the confidentiality mode but redacted the recording such that the shared content is not captured within the video data.

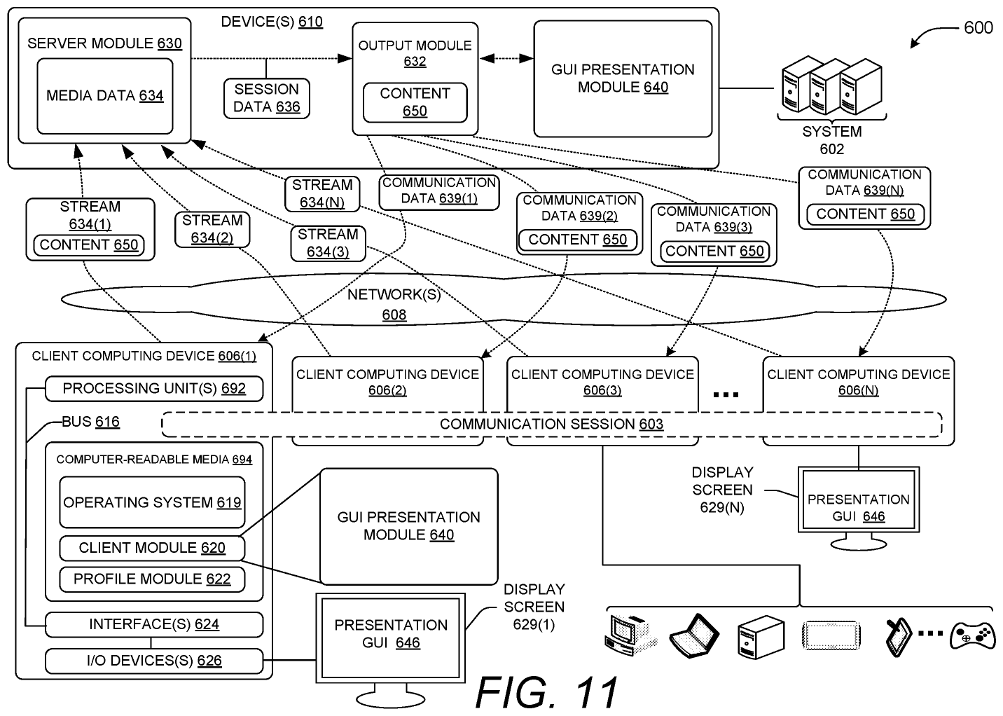

FIG. 11 is a diagram illustrating an example environment 600 in which a system 602 can implement the techniques disclosed herein. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 603. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations. A communication session 603 can include a start time and an end time, which can determine when video streams and live audio can be shared. Text and content can be shared outside of the start time and end time.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds may comprise such audio and visual data, one or more still images, and/or one or more avatars. The one or more still images may also comprise one or more avatars.

Another example of an individual stream of live or recorded content can comprise media data that includes an avatar of a user participating in the communication session along with audio data that captures the speech of the user. Yet another example of an individual stream of live or recorded content can comprise media data that includes a file displayed on a display screen along with audio data that captures the speech of a user. Accordingly, the various streams of live or recorded content within the communication data enable a remote meeting to be facilitated between a group of people and the sharing of content within the group of people. In some implementations, the various streams of live or recorded content within the communication data may originate from a plurality of co-located video cameras, positioned in a space, such as a room, to record or stream live a presentation that includes one or more individuals presenting and one or more individuals consuming presented content.

A participant or attendee can view content of the communication session 603 live as activity occurs, or alternatively, via a recording at a later time after the activity occurs. In the examples described herein, client computing devices 606(1) through 606(N) participating in the communication session 603 are configured to receive and render for display, on a user interface of a display screen, communication data. The communication data can comprise a collection of various instances, or streams, of live and/or recorded content. For example, an individual stream of content can comprise media data associated with a video feed (e.g., audio and visual data that capture the appearance and speech of a user participating in the communication session). Another example of an individual stream of content can comprise media data that includes an avatar of a user participating in the conference session along with audio data that captures the speech of the user. Yet another example of an individual stream of content can comprise media data that includes a content item displayed on a display screen and/or audio data that captures the speech of a user. Accordingly, the various streams of content within the communication data enable a meeting or a broadcast presentation to be facilitated amongst a group of people dispersed across remote locations.

A participant or attendee to a communication session is a person that is in range of a camera, or other image and/or audio capture device such that actions and/or sounds of the person which are produced while the person is viewing and/or listening to the content being shared via the communication session can be captured (e.g., recorded). For instance, a participant may be sitting in a crowd viewing the shared content live at a broadcast location where a stage presentation occurs. Or a participant may be sitting in an office conference room viewing the shared content of a communication session with other colleagues via a display screen. Even further, a participant may be sitting or standing in front of a personal device (e.g., tablet, smartphone, computer, etc.) viewing the shared content of a communication session alone in their office or at home.

The system 602 of FIG. 11 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses.

Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 11 illustrates that client computing device 606(1) is in some way connected to a display device (e.g., a display screen 629(N)), which can display a UI according to the techniques described herein.

In the example environment 600 of FIG. 11, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 11) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 11, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening,” device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/o device 626 on each client computer.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

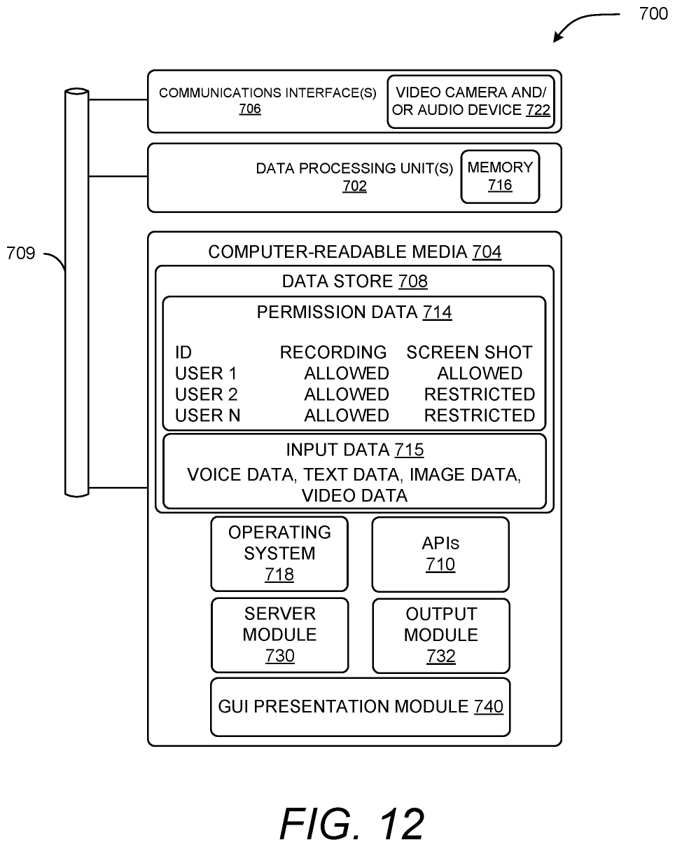

FIG. 12 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store session data (e.g., session data 636 as shown in FIG. 11), profile data (e.g., associated with a participant profile), and/or other data. The session data can include a total number of participants (e.g., users and/or client computing devices) in a communication session, activity that occurs in the communication session, a list of invitees to the communication session, and/or other data related to when and how the communication session is conducted or hosted.

The data store 708 may also include permission data 714, to control access and execution rights of each user. The permission data 714 can include identifiers for each user specific mission attributes for allowing users to execute recording functions of a communication program, attributes for allowing users to execute screen shot functions of a communication program, attributes for allowing users to execute meeting invitation functions of a communication program, etc. In addition, the data store 708 can also include input data 715 that can be received by individual computing devices. The input data can include voice data, text data, image data, video data, etc.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A computer-implemented method for modifying security permissions controlling the communication of confidential content using vocal activity of a communication session, the computer-implemented method configured for execution on a computing system comprising:
monitoring, by the computing system, input data defining vocal activity of a user participating in the communication session;
based on the vocal activity of the user participating in the communication session, determining keywords included in the vocal activity uniquely identifying the confidential content shared in the communication session, wherein the keywords of the vocal activity uniquely identify the confidential content without using keywords from other forms of input of the user;
in response to determining that the keywords of the input data caused by the vocal activity meet a threshold requirement for indicating that the confidential content is to be shared, executing a set of batched operations causing the computing system to activate a confidentiality mode comprising:
modifying the security permissions for one or more users of the communication session wherein the modification causes a transition from a first state of the security permissions allowing recordings of the confidential content shared in the communication session to a second state of the security permissions restricting recordings of the confidential content shared in the communication session; and
modifying a display of the confidential content to provide a visual indication of the confidentiality mode in response to the transition of the security permissions from the first state of the security permissions allowing recordings of the confidential content to the second state of the security permissions restricting recordings of the confidential content.

2. The computer-implemented method of claim 1, wherein the visual indication of the confidentiality mode includes displaying a watermark that is positioned as an overlay over the confidential content.

3. The computer-implemented method of claim 1, wherein the visual indication of the confidentiality mode includes displaying a text message that is positioned in association with the confidential content, wherein the text message indicates that the computing system is operating in the confidentiality mode.

4. The computer-implemented method of claim 1, wherein the computing system continues to operate in the confidentiality mode as new content is shared by the user to other users of the communication session, wherein the computing system operates in the confidentiality mode until the user provides an input to deactivate the confidentiality mode.

5. The computer-implemented method of claim 1, wherein restricting recordings of the confidential content shared in the communication session includes restricting one or more computing devices associated with other users from performing operations for capturing a screen shot.

6. The computer-implemented method of claim 1, wherein restricting recordings of the confidential content shared in the communication session includes restricting one or more computing devices associated with other users from performing operations for taking screen shots, wherein a visual indicator is displayed on a display device of the one or more computing devices in response to receiving an input for invoking the operations for taking a screen shot.

7. The computer-implemented method of claim 1, wherein the modification of the security permissions restricts one or more computing devices associated with other users from inviting additional participants to the communication session.

8. The computer-implemented method of claim 7, further comprising, causing a display of a warning to provide notice that the one or more computing devices associated with the other users is inviting the additional participants to the communication session.

9. The computer-implemented method of claim 1, wherein the modification of the security permissions restricts one or more computing devices associated with other users from inviting additional participants to the communication session, wherein the computer-implemented method further comprises:
receiving an input from a second user, the input identifying a third user to be invited to the communication session; and
restricting the third user from joining the communication session in response to the transition of the security permissions from the first state of the security permissions to the second state of the security permissions, wherein the second state of the security permissions restricts the addition of the third person from joining the communication session and from receiving the confidential content.

10. A computing device for modifying security permissions controlling the communication of confidential content using vocal activity of a communication session, comprising:
one or more processing units; and
a computer-readable storage medium having encoded thereon computer-executable instructions to cause the one or more processing units to perform a method comprising:
monitoring, by the computing device, input data defining vocal activity of a user participating in the communication session;
based on the vocal activity of the user participating in the communication session, determining keywords included in the vocal activity uniquely identifying the confidential content shared in the communication session, wherein the keywords of the vocal activity uniquely identify the confidential content without using keywords from other forms of input of the user;
in response to determining that the keywords of the input data caused by the vocal activity meet a threshold requirement for indicating that the confidential content is to be shared, executing a set of batched operations causing the computing device to activate a confidentiality mode comprising:
modifying the security permissions for one or more users of the communication session wherein the modification causes a transition from a first state of the security permissions allowing recordings of the confidential content shared in the communication session to a second state of the security permissions restricting recordings of the confidential content shared in the communication session; and
modifying a display of the confidential content to provide a visual indication of the confidentiality mode in response to the transition of the security permissions from the first state of the security permissions allowing recordings of the confidential content to the second state of the security permissions restricting recordings of the confidential content.

11. The computing device of claim 10, wherein the visual indication of the confidentiality mode includes displaying a watermark that is positioned as an overlay over the confidential content.

12. The computing device of claim 10, wherein the visual indication of the confidentiality mode includes displaying a text message that is positioned in association with the confidential content, wherein the text message indicates that the computing system is operating in the confidentiality mode.

13. The computing device of claim 10, wherein the computing device continues to operate in the confidentiality mode as new content is shared by the user to other users of the communication session, wherein the computing device operates in the confidentiality mode until the user provides an input to deactivate the confidentiality mode.

14. (canceled)

15. A computer-readable storage medium having encoded thereon computer-executable instructions to cause the one or more processing units of a computing device to perform a method comprising:
monitoring, by the computing device, input data defining vocal activity of a user participating in the communication sessions;
based on the vocal activity of the user participating in the communication session, determining keywords included in the vocal activity uniquely identifying the confidential content shared in the communication session, wherein the keywords of the vocal activity uniquely identify the confidential content without using keywords from other forms of input of the user;
in response to determining that the keywords of the input data caused by the vocal activity meet a threshold requirement for indicating that the confidential content is to be shared, executing a set of batched operations causing the computing device to activate a confidentiality mode comprising:
modifying the security permissions for one or more users of the communication session wherein the modification causes a transition from a first state of the security permissions allowing recordings of the confidential content shared in the communication session to a second state of the security permissions restricting recordings of the confidential content shared in the communication session; and
modifying a display of the confidential content to provide a visual indication of the confidentiality mode in response to the transition of the security permissions from the first state of the security permissions allowing recordings of the confidential content to the second state of the security permissions restricting recordings of the confidential content.

16. The computer-readable storage medium of claim 15, wherein the visual indication of the confidentiality mode includes displaying a watermark that is positioned as an overlay over the confidential content.

17. The computer-readable storage medium of claim 15, wherein the visual indication of the confidentiality mode includes displaying a text message that is positioned in association with the confidential content, wherein the text message indicates that the computing system is operating in the confidentiality mode.

18. The computer-readable storage medium of claim 15, wherein the computing device continues to operate in the confidentiality mode as new content is shared by the user to other users of the communication session, wherein the computing device operates in the confidentiality mode until the user provides an input to deactivate the confidentiality mode.

19. The computer-readable storage medium of claim 15, wherein restricting recordings of the confidential content shared in the communication session includes restricting one or more computing devices associated with other users from performing operations for capturing a screen shot.

20. The computer-readable storage medium of claim 15, wherein the modification of the security permissions restricts one or more computing devices associated with other users from inviting additional participants to the communication session, wherein the computer-implemented method further comprises:
receiving an input from a second user, the input identifying a third user to be invited to the communication session; and
restricting the third user from joining the communication session in response to the transition of the security permissions from the first state of the security permissions to the second state of the security permissions, wherein the second state of the security permissions restricts the addition of the third person from joining the communication session and from receiving the confidential content.

21. The method of claim 1, further comprising receiving a document comprising the keywords during the communication session such that the other forms of input include the document.
